(19) United States
(12) Patent Application Publication
(10) Pub. No.: US 2014/0341785 A1
(43) Pub. Date: Nov. 20, 2014

(54) RADIANT FOUNTAIN ARCHITECTURE CHEMICAL REACTOR

(71) Applicant: Sundrop Fuels, Inc., Longmont, CO (US)

(72) Inventors: Wayne W. Simmons, Longmont, CO (US); Christopher Perkins, Boulder, CO (US); Paul Lichty, Westminster, CO (US); Timothy E. Laska, Loveland, OH (US)

(73) Assignee: Sundrop Fuels, Inc., Longmont, CO (US)

(21) Appl. No.: 14/278,152

(22) Filed: May 15, 2014

Related U.S. Application Data
(60) Provisional application No. 61/823,661, filed on May 15, 2013.

(51) Int. Cl. B01J 19/24

(52) U.S. Cl. CPC B01J 19/2415
USPC 422/162; 422/659

(57) ABSTRACT

A chemical plant includes a radiant heat-driven chemical reactor having generally concentric reactor tubes with an inner tube and an outer tube located inside a cavity of a thermal receiver. Particles of biomass, or natural gas, and an entrainment gas are fed into the inner tube near a bottom of the tube. The biomass and the entrainment gas flow upward through the inner tube into an upper plenum, and then flow downward through an annular space between the inner tube and the outer tube. The concentric reactor tubes and the thermal receiver are configured to cooperate such that heat is radiantly transferred by primarily absorption and re-radiation to drive the biomass gasification reaction or natural gas reformation reaction of reactants flowing through the reactor tubes in the vertical sections of the reactor, and turbulent flow and mixing of the reactants occurs in the upper plenum part of the reactor.

### RELATED APPLICATIONS

This application claims the benefit of and priority to U.S. Provisional Application, entitled “FOUNTAIN ARCHITECTURE RADIANT HEAT REACTOR,” filed on May 15, 2013 having application Ser. No. 61/823,661, which is incorporated herein by reference.

### FIELD

The design generally relates to a fountain architecture radiant heat reactor. In an embodiment, the design relates to an integrated plant that uses this biomass to produce a liquid fuel from the biomass gasified in the fountain architecture radiant heat reactor.

### BACKGROUND

Complex, capital intensive, reactors that require large amounts of energy have tried to convert organic material into a useable fuel. A good reactor design is needed.

### SUMMARY

In an embodiment, a chemical plant that includes a radiant heat-driven chemical reactor that has one or more generally concentric reactor tubes with an interior reactor tube and one or more outer reactor tubes located inside a cavity of a thermal receiver is discussed. Particles of biomass, or natural gas, and steam are fed into the interior tube near a bottom of the tube. The biomass particles and an entrainment gas or natural gas flow upward through the interior tube into an upper plenum, and then flow downward through an annular space between the interior tube and the outer tube. The chemical reactor is configured to 1) gasify particles of biomass in a presence of steam (H2O) in a gasification reaction to produce a low CO2 synthesis gas that includes hydrogen, carbon monoxide gas and less than 15% CO2 by total volume generated in the gasification reaction of the particles of biomass, 2) reform natural gas in a non-catalytic reformation reaction, and 3) any combination of both, using thermal energy from a radiant heat source.

The concentric reactor tubes and the thermal receiver are geometrically configured to cooperate such that heat is radiantly transferred to the particles of biomass in order to provide enough energy required for the 1) gasification reaction of the particles of biomass, 2) reformation reaction of the natural gas, and 3) any combination of both, in order to drive the reaction(s) primarily with radiant heat to produce the low CO2 synthesis gas. The concentric reactor tubes and the thermal receiver are geometrically configured to cooperate such that heat is radiantly transferred by primarily radiation absorption and re-radiation, as well as secondarily through convection and conduction heat transfer to the reacting particles to drive the biomass gasification reaction or to inert particles accompanying natural gas in the reformation reaction. In an upper vertical section of the inner tube, turbulent flow and mixing of the reactants occurs in this upper plenum part of the reactor. The radiant heat source may be a set of one or more gas fired heaters in thermal communication with the radiant heat-driven chemical reactor. The radiant heat source contributes with the steam to cause an operating temperature of between 900 degrees C. to 1600 degrees C. in the radiant heat-driven chemical reactor. The gas fired heaters supply heat to the 1) biomass, 2) natural gas, 3) inert heat transfer particles, and 4) any combination of these traveling through the tubes, initially through an exterior wall of a most exterior outer tube and then inward to the inner tube in order to transfer heat to the reactants flowing in the inner and outer tubes, which limits a thermal stress difference between a maximum heat flux and a mean heat flux felt across each of the tubes.

### BRIEF DESCRIPTION OF THE DRAWINGS

The multiple drawings refer to the example embodiments of the design.

FIG. 1 illustrates a flow schematic of an embodiment of a steam explosion unit having an input cavity to receive biomass as a feedstock, two or more steam supply inputs, and two or more stages to pre-treat the biomass for subsequent supply to a biomass gasifier.

FIG. 2 illustrates an embodiment of a flow diagram of an integrated plant to generate syngas from biomass and generate a liquid fuel product from the syngas.

FIG. 3-1 is a schematic illustrating an exemplary architecture of a fountain gasifier design of a radiant heat reactor.

FIG. 3-1A is a side plane view of an exemplary embodiment of a radiant heat reactor having a fountain gasifier design.

FIG. 3-1B is a side section view of the exemplary embodiment of the radiant heat reactor illustrated in FIG. 3-1A.

FIG. 3-1C is a side section view of a bottom area of the exemplary embodiment of the radiant heat reactor illustrated in FIG. 3-1B.

FIG. 3-2 is a top view of an alternative embodiment of a radiant heat reactor having a bayonet reactor design.

FIG. 3-3 is a side section view of an alternative embodiment of a radiant heat reactor having a bayonet reactor design.

FIG. 3-4 is a schematic illustrating an embodiment of a radiant heat reactor.

FIGS. 4A-C illustrates different levels of magnification of an example chip of biomass having a fiber bundle of cellulose fibers surrounded and bonded together by lignin.

FIG. 4D illustrates example chips of biomass exploded into fine particles of biomass.

FIG. 4E illustrates a chip of biomass having a bundle of fibers that are frayed or partially separated into individual fibers.

The additional drawings illustrate more aspects and embodiments of the design.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific chemicals, named components, connections, types of heat sources, etc., in order to provide a thorough understanding of the present design. It will be apparent, however, to one skilled in the art that the present design may be practiced without these specific details. In other instances, well known components or methods have not been described in detail but rather in a block diagram in order to avoid unnecessarily obscuring the present design. Thus, the specific details set forth are merely exemplary. The specific details may be varied from and still be contemplated to be within the spirit and scope of the present design. Characteristics and components used in one embodiment may, in some instances, be used in another embodiment.

In general, a number of example processes for and apparatuses associated with a radiant heat driven reactor are described. The following drawings and text describe various example implementations for an integrated plant using the pre-treatments of biomass with a radiant heat tube reactor design. In an embodiment, a chemical plant includes a radiant heat-driven chemical reactor having generally concentric reactor tubes with an inner tube and an outer tube located inside a cavity of a thermal receiver. Particles of biomass, or natural gas, and an entrainment gas are fed into the inner tube near a bottom of the tube. The particles of biomass and the entrainment gas flow upward through the inner tube into an upper plenum, and then flow downward through an annular space between the inner tube and the outer tube. A gas fired heat source in thermal communication with the radiant heat-driven chemical reactor causes an operating temperature of between 900 degrees C. to 1600 degrees C. and supplies the heat to the 1) biomass, or 2) the natural gas, initially through an exterior wall of the outer tube in order to transfer heat to the reactants flowing in the annular space and the inner tube in order to minimize the difference between a maximum heat flux and a mean heat flux flowing across each of the tubes, reducing the difference between the maximum thermal stress and mean thermal stress in the system. As the maximum thermal stress sets the design reactant flow rate, a smaller difference translates into a larger allowable throughput of reactants.

The chemical reactor may be configured to 1) gasify the particles of biomass in a presence of the steam (H2O) to produce a low CO2 synthesis gas that includes hydrogen, carbon monoxide gas, and less than 15% CO2 by total volume generated in a gasification reaction of the particles of biomass, or 2) reform natural gas in a non-catalytic reformation reaction, using thermal energy from a radiant heat source, such as gas heaters, concentrated solar energy, or other source. The concentric reactor tubes and the thermal receiver are configured to cooperate such that heat is radiantly transferred to the particles of biomass in order to provide enough energy required for 1) the gasification reaction of the particles of biomass, or 2) reformation of the natural gas, in order to drive the gasification reaction primarily with radiant heat to produce the low CO2 synthesis gas. The concentric reactor tubes and the thermal receiver are configured to cooperate such that heat is radiantly transferred by primarily absorption and re-radiation, as well as secondarily through convection and conduction to the reacting particles to drive the biomass gasification reaction or natural gas reformation reaction of reactants flowing through the reactor tubes in the vertical sections of the reactor, and turbulent flow and mixing of the reactants occurring in the upper plenum part of the reactor contributes to dispersion of the particles of biomass within the entrainment gas.

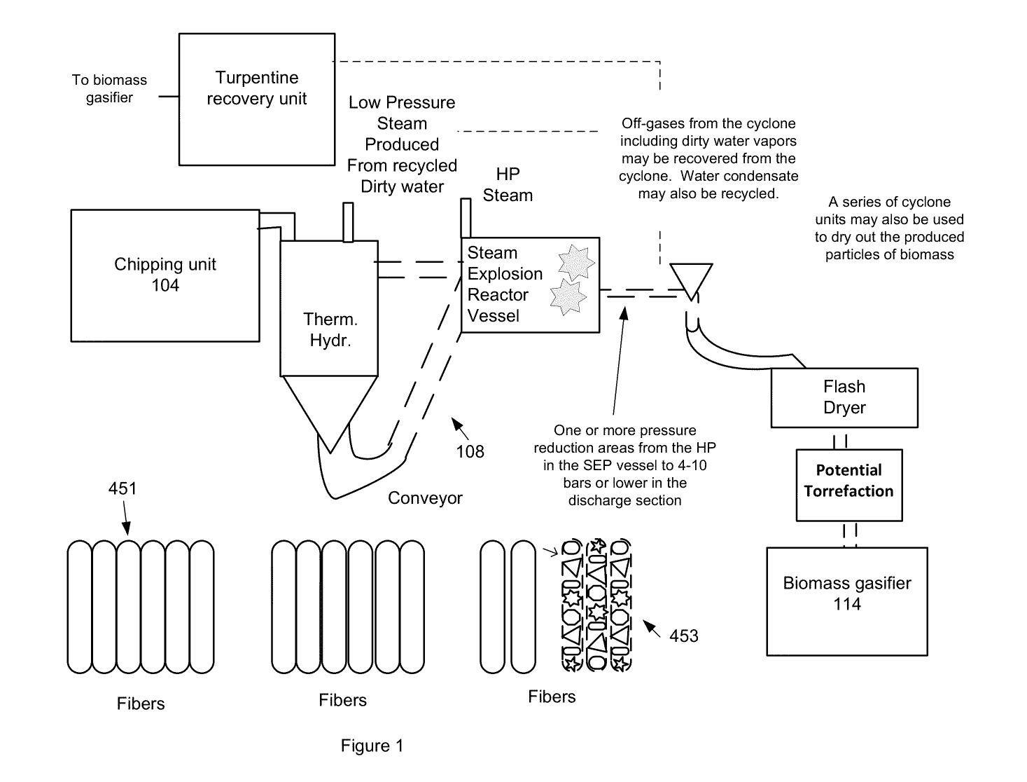

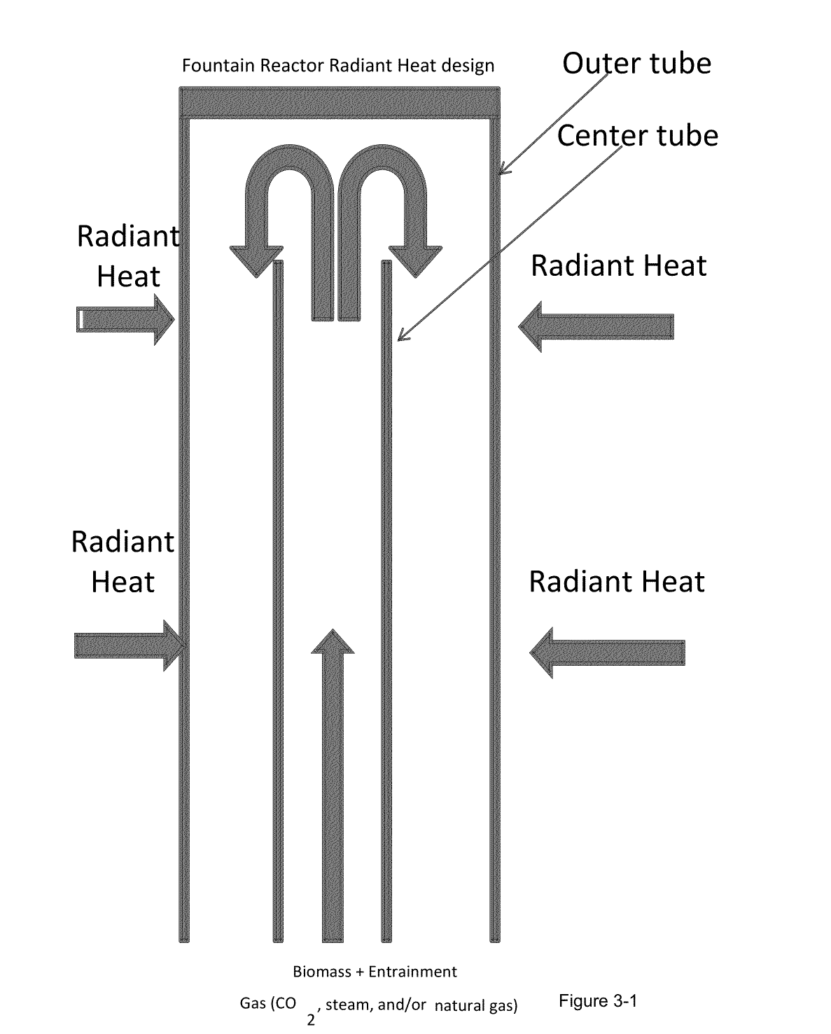

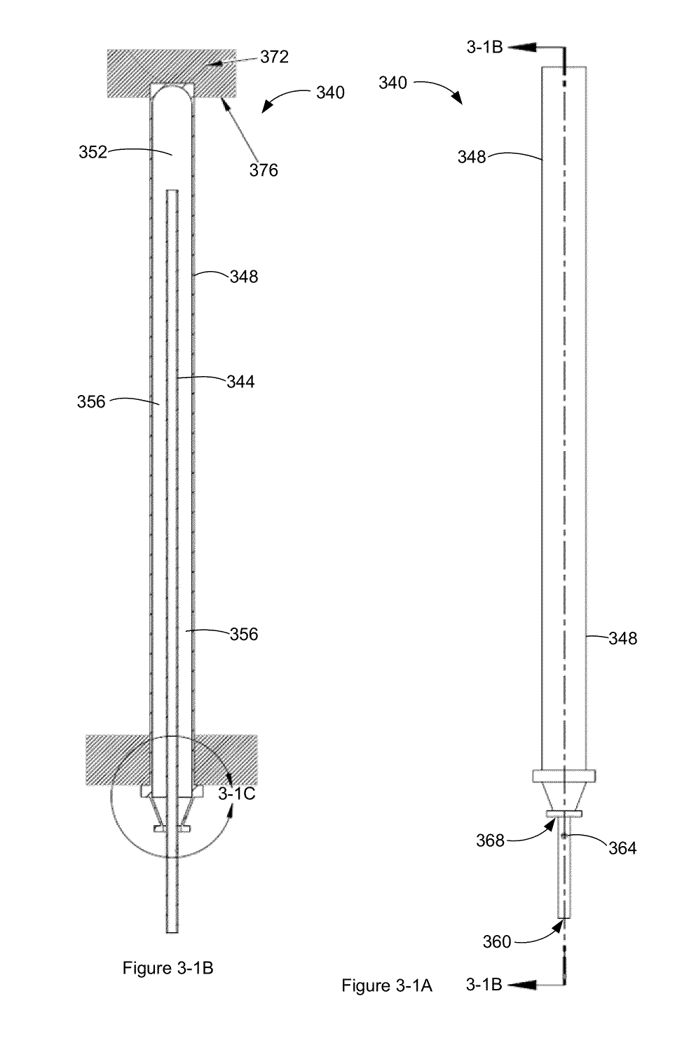

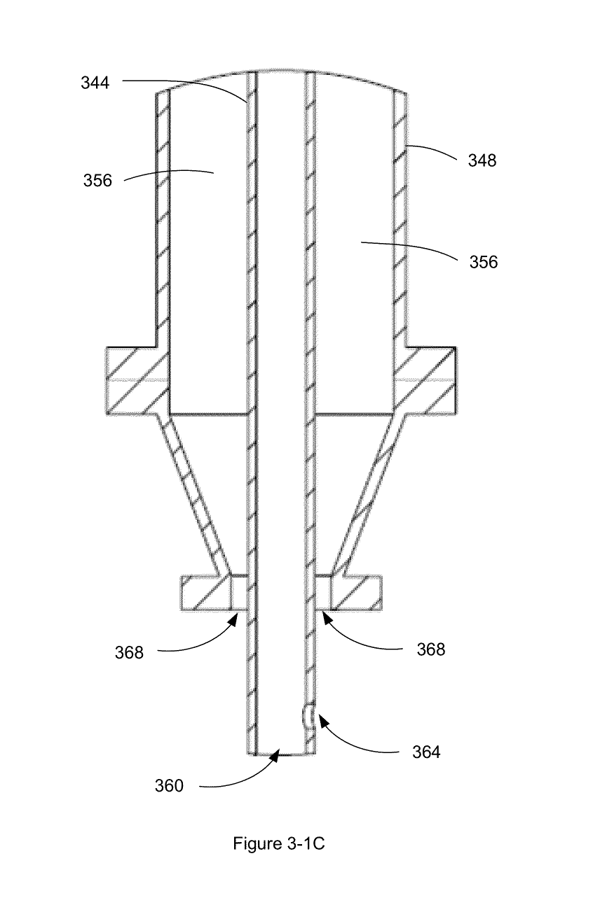

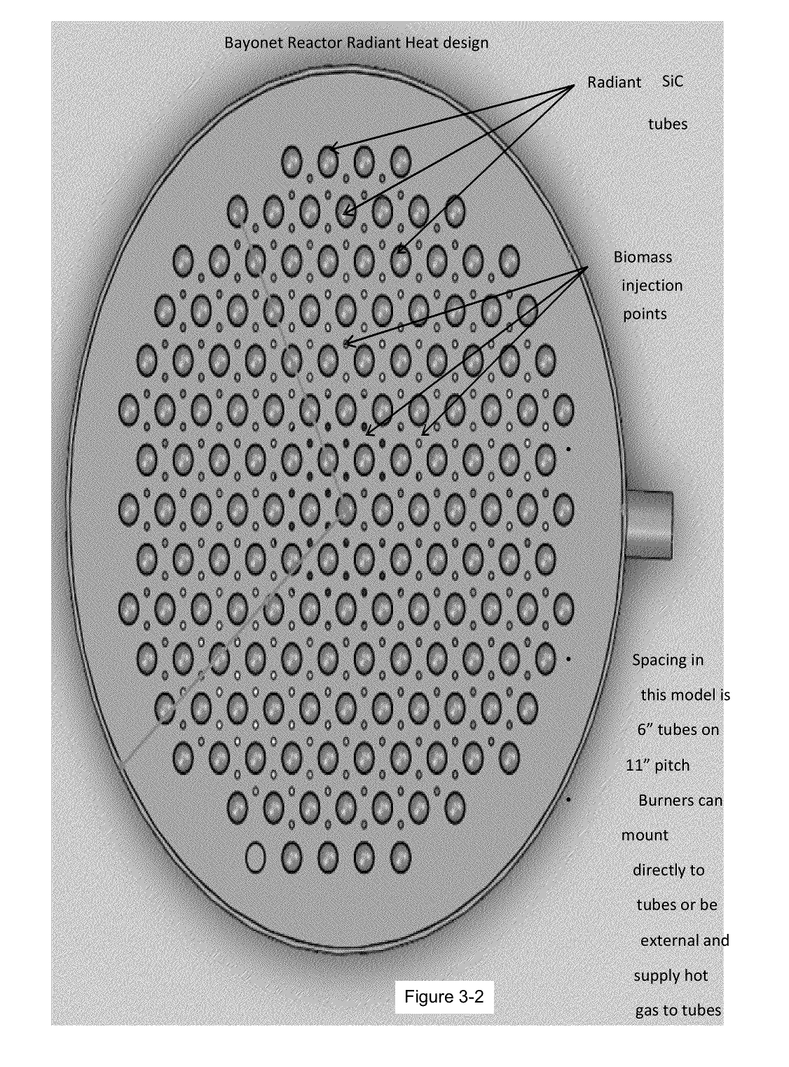

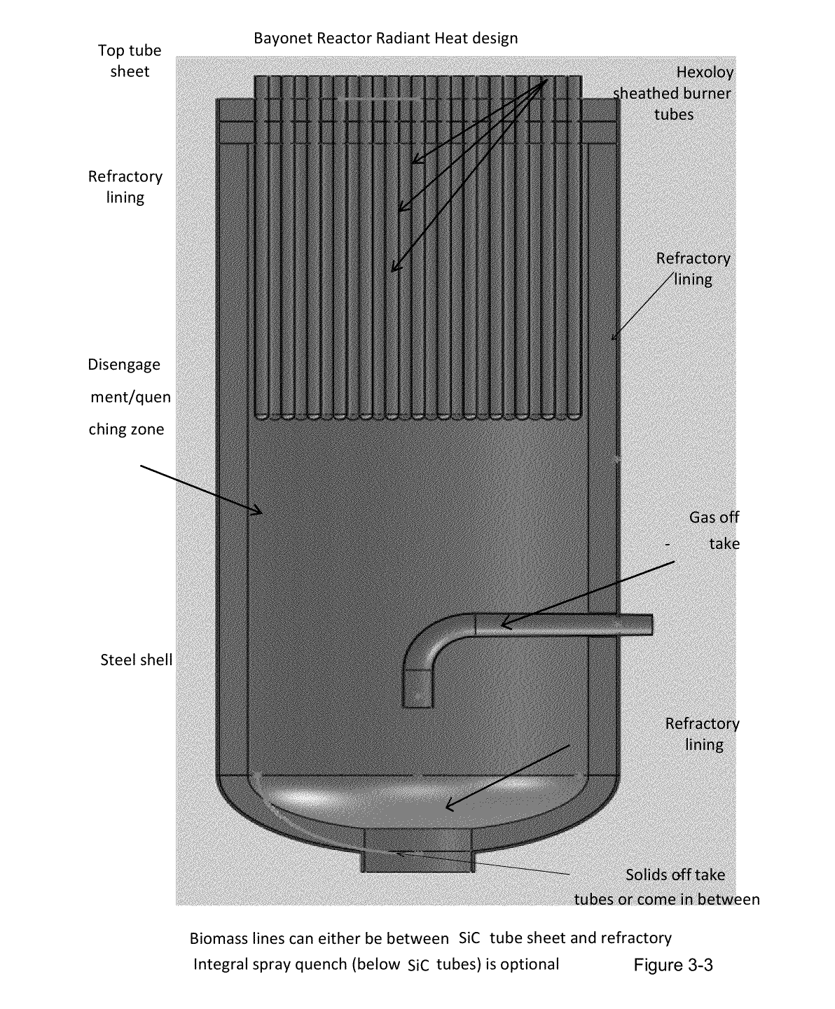

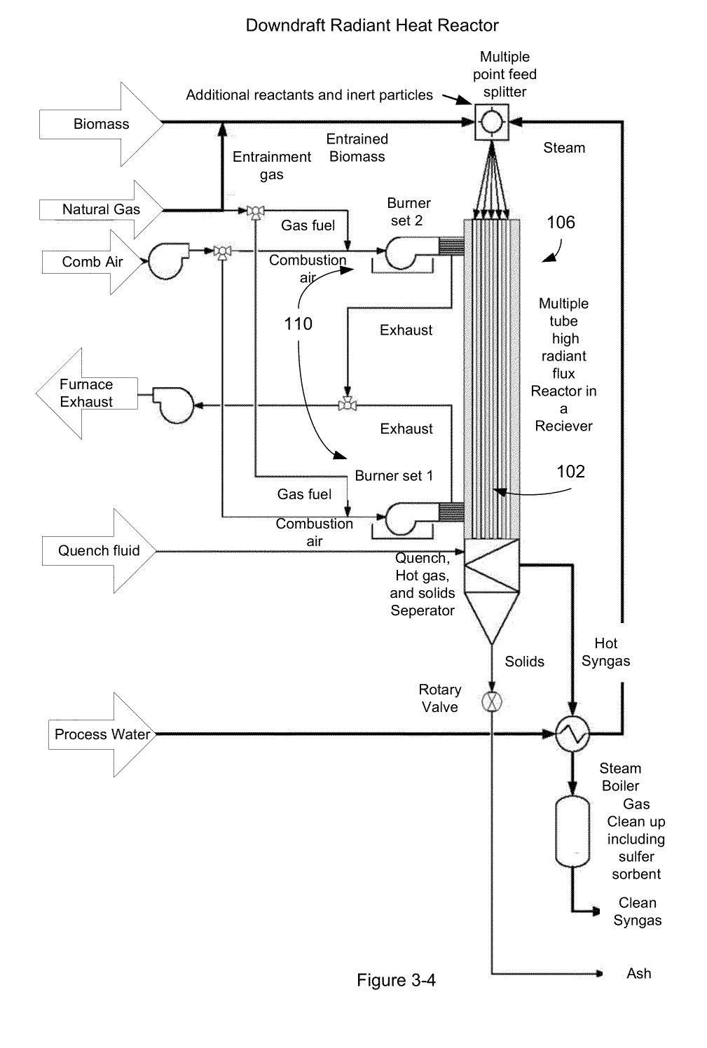

FIG. 3-1 shows an exemplary schematic architecture of the fountain gasifier design of a radiant heat reactor. Entrainment gas carrying the biomass enters from the bottom of the fountain gasifier design, travels generally vertically or upward through a central tube into an upper plenum. Turbulent gas flow occurs in the upper plenum to evenly distribute the heat to the 1) biomass particles being carried, 2) natural gas flowing as a reactant gas, and 3) any combination of both. The biomass particles then flow/fall down an area adjacent the interior surface of the outer tube to continue the biomass gasification reaction and ensure that at least greater than 90% of the carbon material is reacted. The entrainment gas may be carbon dioxide, steam, and/or natural gas.

The fountain gasifier design provides better uniform mixing of reactants due to turbulent flow and thus better conversion of reactants. The fountain gasifier design may have lower stresses due to counter flow heating on the outside of the center reactor tube.

The fountain gasifier may include generally concentric tubes with interior and outer tubes. One or more inlets for biomass and entrainment gas are provided through a lower portion of the inner tube. A generally annular space is provided between the inner tube and outer tube with an exit area at a lower portion of the outer tube, such as through an exit port between the outer tube and inner tube at the lower end of the outer tube. The inner tube and outer tube may be longitudinally offset, so that a lower end of the inner tube may extend beyond the lower end of the outer tube, and the upper end of the outer tube may extend beyond the upper end of the inner tube. The upper end of the outer tube is closed to create a mixing area in a space above the inner tube and within the walls of the outer tube. Heat may be supplied to the biomass through the exterior wall of the outer tube. The fountain configuration of the concentric tubes causes the particles of biomass to pass through the radiant heat-driven chemical reactor along two or more passes, including a first upward pass through the interior tube and then a second downward pass through an annular space between the inner and outer tubes.

In an exemplary embodiment, the gasifier may use a system to counter pressure thrust at the top of the system. Some embodiments of the outer tube may incorporate either 1) a spring or 2) a hydraulic maintenance system. A spring may be used to passively maintain the force on the system such that the spring expands or contracts under pressure to counteract pressure thrust. A hydraulic system may be used to actively control the downward force on the system such that a pressure sensor may be linked to a controller that activates a hydraulic piston to expand or contract the outer tube as necessary to decrease or increase downward force and neutralize stress from pressure thrust.

FIG. 3-1A through 3-1C illustrate a fountain gasifier 340 including generally concentric reactor tubes comprising an interior tube 344 and an outer tube 348 which may be located within a cavity of the thermal receiver. The concentric reactor tubes preferably are comprised of a ceramic material, a metal coated with a ceramic, a metal lined with a ceramic, a refractory metal coated with a ceramic, a refractory metal lined or clad with an oxidation resistant metal, or any combination of these. In some embodiments, the radiant heat-driven fountain gasifier 340 may include one or more inlets for biomass and entrainment gas coupled through a lower portion of the inner tube 344. In the illustrated embodiment of FIGS. 3-1A through 3-1C, the fountain gasifier 340 includes a biomass feed 360 and a steam inlet 364, whereby particles of biomass, or natural gas, and steam are fed into the inner tube 344. The biomass feed 360 is configured to receive moist, fine particles of biomass prepared by the steam explosion unit, where the particle size of the biomass is generally less than 1 mm and preferably less than 500 microns. The fountain gasifier 340 is configured to react the moist, fine particles of biomass in a rapid biomass gasification reaction to produce syngas components. In another embodiment, the fountain gasifier 340 may be used as a non-catalytic reformer of natural gas.

An annular space 356 is provided between the inner tube 344 and outer tube 348 with an exit port 368 between the outer tube 348 and the inner tube 344 at the lower end of the outer tube 348. In the illustrated embodiment, the inner tube 344 and the outer tube 348 are longitudinally offset, such that a lower end of the inner tube 344 extends beyond the lower end of the outer tube 348, and the upper end of the outer tube 348 extends beyond the upper end of the inner tube 344. In some embodiments, the inner and outer tubes 344, 348 have a length of between substantially 10 feet to 24 feet. In some embodiments, the length of the inner tube 344 is a percentage of the length of the fountain gasifier 340 of between 50% and 98%. Preferably, the upper end of the outer tube 348 is closed, forming an upper plenum 352, which operates as a mixing area above the inner tube 344 and within the walls of the outer tube 348. Generally, biomass particles and entrainment gas flow upward through the inner tube 344 into the upper plenum 352, and then flow downward through the annular space 356 into an adjacent concentric tube.

The biomass particles and entrainment gas may pass through the concentric reactor tubes to spread the heat flux to the inner flow across the external tube; and thereby, provide for internal radiant energy recuperation. In an embodiment, spreading the heat flux to the inner flow across the external tube facilitates a smaller difference between a maximum heat flux and a mean heat flux, provides a lower thermal stress, and provides a greater throughput capability. This is because thermal stress (allowable heat flux) is more even, giving the ability to run higher average heat flux.

The annular space 356 between an outer diameter of the inner tube 344 and an inner diameter of the outer tube 348 is set a specific ratio so as to maintain a velocity of the flowing reactants and properly exchange energy via radiant heat energy exchange. Preferably, a spacing distance ratio is set between an outer diameter of the inner tube 344 and an inner diameter of an adjacent outer tube 348 is set to be between 1:3 and 1:5 in order to maintain a velocity of the flowing reactants and properly exchange energy via a radiant heat energy exchange. In some embodiments, the outer diameter of the outer tube 348 is between substantially 4 inches (″) and 12″ with a wall thickness of between 0.25″ and 0.375″. In some embodiments, the inner diameter of the inner tube 344 is between substantially 1″ and 6″ with a wall thickness of between 0.25″ and 1.0″.

In some embodiments, more than one outer tube 348 may be incorporated into the fountain gasifier 340. For example, in another embodiment the fountain gasifier 340 may include the inner tube 344, the outer tube 348, and two additional exterior tubes outside of the outer tube 348. In such an embodiment, the fountain gasifier 340 may pass the biomass through more the two passes, including a first upward pass through the inner tube 344 and a second downward pass through the annular space 356 between the inner and outer tubes 344, 348, followed by another upward pass through an annular space exterior to the outer tube 348 and another downward pass through an outer-most annular space within the outer-most reactor tube.

The fountain gasifier 340 illustrated in FIGS. 3-1A through 3-1C is advantageously configured to 1) gasify particles of biomass in a presence of steam (H2O) to produce a low CO2 synthesis gas that includes hydrogen, carbon monoxide gas and less than 15% CO2 by total volume generated in a gasification reaction of the particles of biomass, and/or 2) reform natural gas in a non-catalytic reformation reaction, using thermal energy from the radiant heat. The concentric reactor tubes and the thermal receiver are configured to cooperate such that heat is transferred to the particles of biomass in order to provide enough energy required for the 1) gasification reaction of the particles of biomass, and/or 2) reformation of the natural gas, in order to drive the gasification reaction primarily with radiant heat transfer and secondarily convection and conduction heat transfer to produce the low CO2 synthesis gas. Thus, the concentric reactor tubes and the thermal receiver are configured to cooperate such that heat is radiantly transferred by primarily absorption and re-radiation, as well as secondarily through convection, and conduction to the reacting particles to drive the biomass gasification reaction or natural gas reformation reaction of reactants flowing through the reactor tubes in the vertical sections of the reactor. Additionally, in the upper plenum, then the turbulent flow creates better convection heat transfer.

Turbulent flow and mixing of the reactants occur in the upper plenum 352 of the fountain gasifier 340. The upper plenum section 352, i.e. turnaround point, mixes and breaks up the particles of biomass or other solids, while distributing heat evenly. The upper plenum section 352 is shaped to direct the biomass particles or other reactants down into a first outer tube 344 to continue the biomass gasification reaction and ensure that at least greater than 80% of the carbon material fed into the inner tube is reacted within the tubes of the radiant heat-driven chemical reactor 340. Although dispersion of the biomass particles in the entrainment gas is important in conventional “once through” systems, the upper plenum 352 of the present design provides a “turnaround” point and mixing point at the top of the system which evenly mixes materials and eliminates this problem. Thus, expansion of the mixture at the top of the inner tube 344 causes the biomass to spread out better, making a design of injection less critical to the overall system. Expansion of the mixture in the upper plenum 352 facilitates an injection point of biomass closer to grade with less conveying distance. Furthermore, the inner and outer tubes 344, 348 can be made up of materials that have a high heat transfer rate characteristics. For example, materials having heat transfer rate characteristics of equal to or greater than 20 Watts per meter Kelvin (i.e. SiC has 60 W/m-K, Alumina has 32 W/m-K) may make up the walls of the vessel and the reactor tubes, which allows the particles of biomass and any reactant gas to achieve a high enough temperature of 1100 degrees C. or greater necessary for substantial tar destruction to less than 200 mg/m̂3 and preferably less than 50 mg/m̂3, and a gasification of greater than 90% of the carbon content of the particles of biomass into reaction products including hydrogen and carbon monoxide gas.

A radiant heat source, such as one or more gas fired heaters, is in thermal communication with the fountain gasifier 340 and the thermal receiver to cause an operating temperature of between 900 degrees C. to 1600 degrees C. The heat is supplied to the 1) biomass, and/or 2) the natural gas initially through an exterior wall of the outer tube 348, in order to transfer heat to the reactants flowing within the inner and outer tubes 344, 348. The spreading of the heat flux across the outer tube 348 to the flow within the inner tube 344 provides a smaller difference between the maximum heat flux and the mean heat flux, which lowers thermal stress and thus provides greater throughput capability. Moreover, the inner and outer tube 344, 348 configuration allows a greater throughput capability of reactants flowing through the inner and outer tubes 344, 348 while maintaining at least a conversion of at least 90% of the biomass into product gases and ash as set by a maximum heat flux allowable across a boundary between adjacent tubes. The greater throughput capability allows more reactant material to flow through the tubes per unit of chemical reactor, being exposed to an overall higher operating temperature than a single tube design of at least 900 degrees C., as well as reduced capital expense cost.

In an embodiment, an entrainment gas source, such as a steam inlet 364, is configured to provide an entrainment gas at a high enough velocity to carrying the biomass particles entering from the bottom of the inner tube by way of the biomass feed 360 to be generally carried vertically upward through the inner tube 344. The particles travel generally vertically or upward through the inner tube 344 into the upper plenum 352. Turbulence of the gas flow carrying the biomass occurs in the upper plenum 352, thereby evenly distributing the heat to the 1) biomass particles, or 2) the natural gas. In other embodiments, one or more flow diverters may be incorporated into the upper plenum 352 so as to shape the flow of the mixing as well as direct any reactant gas and biomass particles down into the outer tube 348.

In the embodiment illustrated in FIG. 3-1B, a counter pressure thrust 372 and an insulator 376 are positioned at the top of the upper plenum of the fountain gasifier 340 in order to counteract an upward thrust force exerted by a combination of the reactant products, the entrainment gas, and any inert particles that create pressure on the top part of the upper plenum. In some embodiments, the outer tube 348 may further include either 1) a spring, or 2) a hydraulic maintenance system to generate the counter pressure thrust at the top of the upper plenum. The spring may be used to passively counteract the pressure thrust within the gasifier such that the spring expands or contracts under pressure or changes due to thermal expansion in order to counteract pressure thrust. The hydraulic maintenance system may include a pressure sensor linked to a controller that activates a hydraulic piston to expand or contract the outer tube 348 as necessary to decrease or increase force on the fountain gasifier 340, thereby actively neutralizing upward pressure thrust generated within the fountain gasifier 340. Advantageously, unlike convention “once through” downdraft reactors, the fountain gasifier 340 has no biomass connections at the top, thereby making thermal expansion simpler to deal with as there are fewer constraints to expansion.

FIG. 1 illustrates a flow schematic of an embodiment of a steam explosion unit having an input cavity to receive biomass as a feedstock, two or more steam supply inputs, and two or more stages to pre-treat the biomass for subsequent supply to a biomass gasifier.

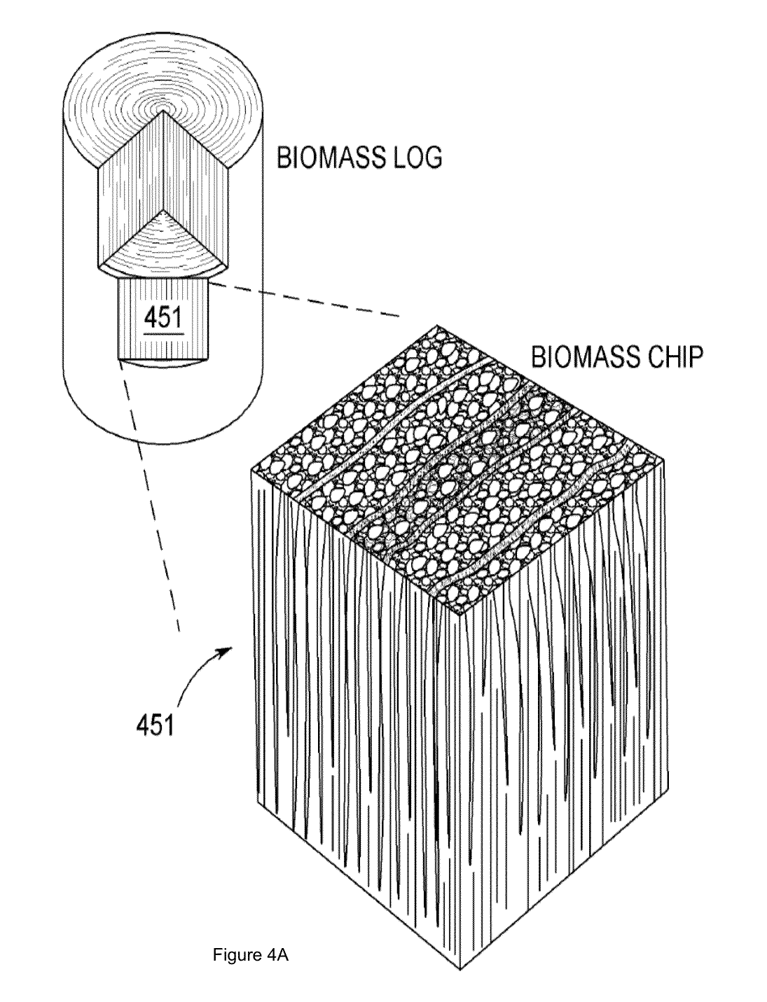

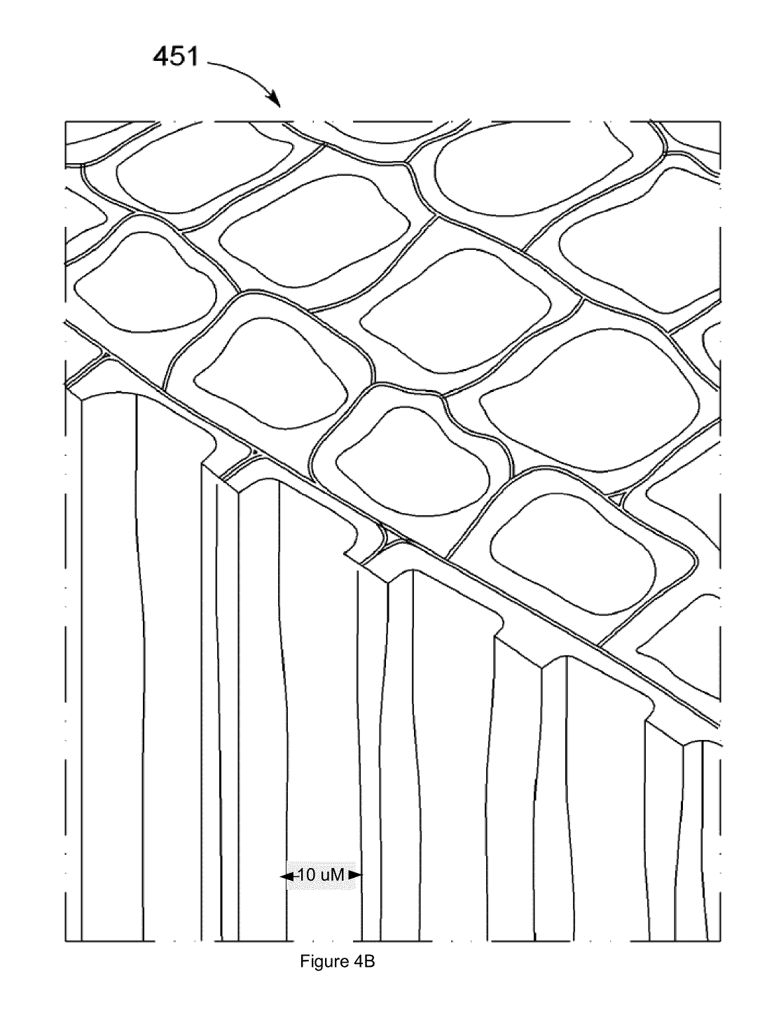

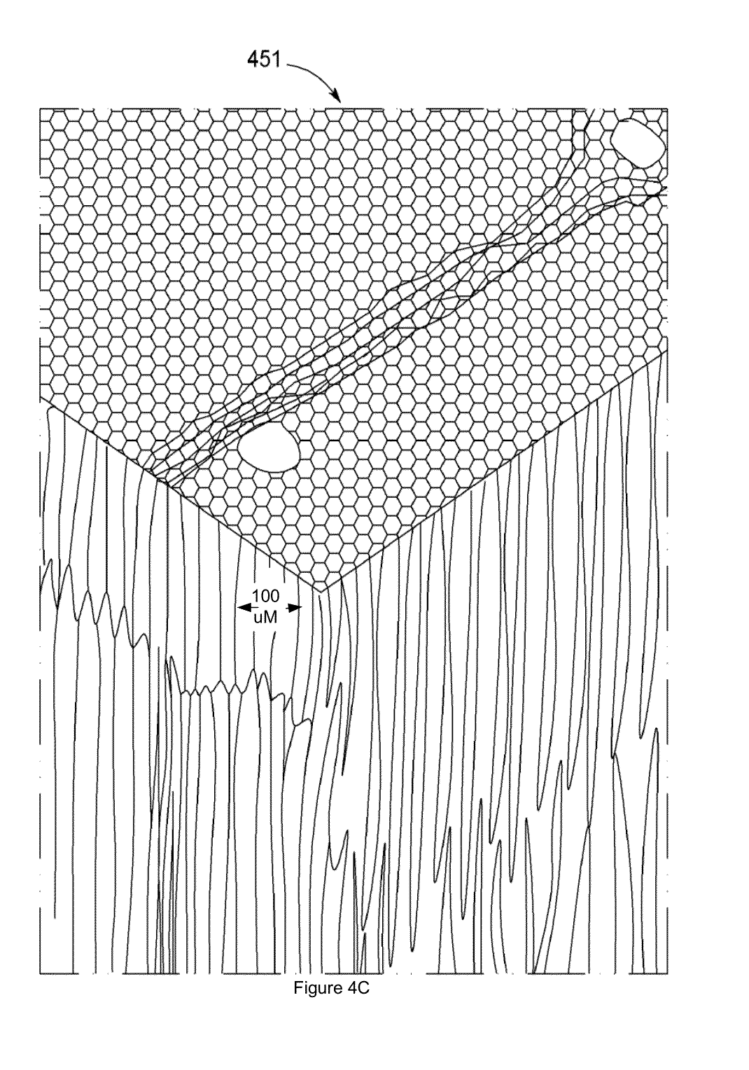

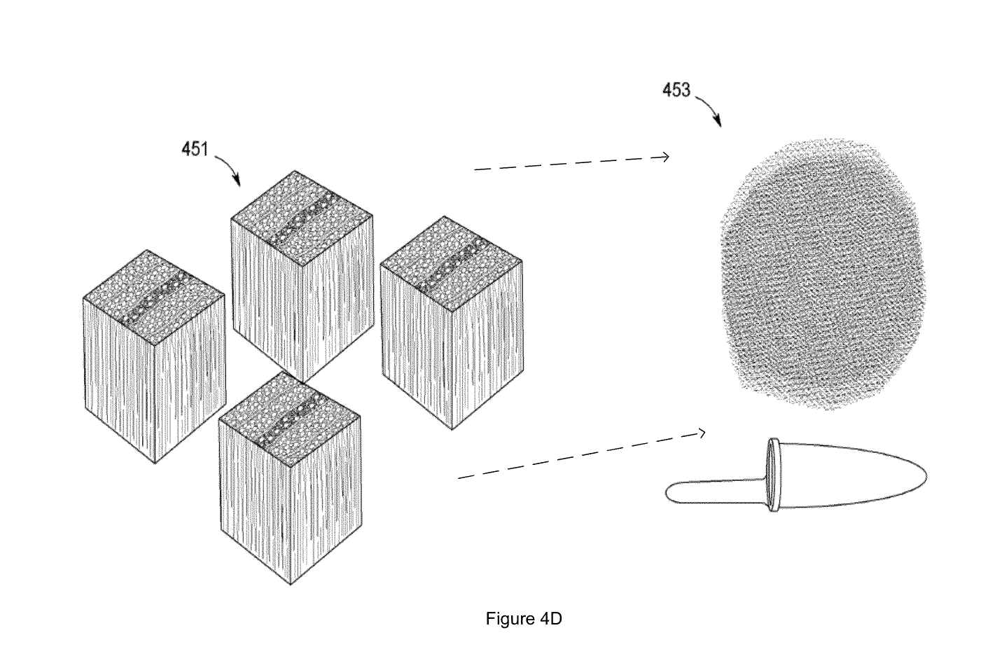

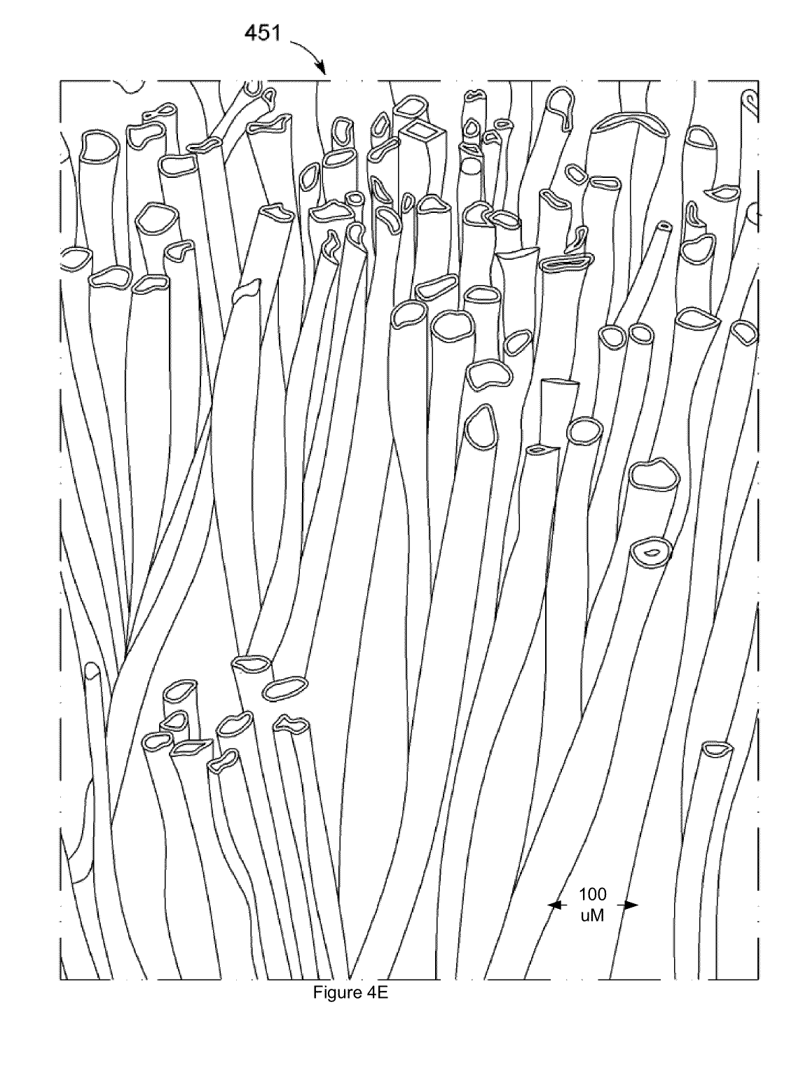

Moisture values in the incoming biomass in chip form can vary from about 15% to 60% for biomass left outside without extra drying. Chips of biomass may be generated by a chipper unit 104 cooperating with some filters with dimensions to create chips of less than about one inch and on average about 0.5 inches in average length and a ¼ inch in thickness on average. (See for example FIG. 4a illustrating a chip of biomass 451 from a log of biomass 453) The biomass chipper unit 104 may contain four or more blades used to chop and chip the biomass. The feed speed of the logs of biomass, the speed of the knife blades, the protrusion distance of the knives and the angle of the knives, can all act to control the chip size. The chips are then screened and those that are oversized may be rechipped. There may be a blending of chips from different sources or timber species to enhance certain properties. A magnet or other scanner may be passed over to detect and remove impurities. Chips of biomass are fed on a conveyor or potentially placed in a pressure vessel in the thermally decomposing stage in the steam explosion unit 108 that starts a decomposition, hydrating/moistening, and softening of the chips of biomass using initially low-pressure saturated steam. The low-pressure saturated steam may be at 100 degrees C. The system may also inject some flow aids at this point, such as recycled ash from the biomass gasifier 114, to prevent clogs and plugging by the biomass chips.

The chipper unit 104 may feed to and the steam explosion unit 108 is configured to receive two or more types of biomass feed stocks, where the different types of biomass include 1) soft woods, 2) hard woods, 3) grasses, 4) plant hulls, and 5) any combination that are blended and steam explosion processed into a homogenized torrefied feedstock within the steam explosion unit 108 that is subsequently collected and then fed into the biomass gasifier 114. The steam explosion unit 108, flash dryer 112, and biomass gasifier 114 are designed to be feedstock flexible without changing out the physical design of the feed supply equipment or the physical design of the biomass gasifier 114 via at least particle size control of the biomass particles produced from steam explosion stage and flash dryer 112.

As discussed, a magnetic filter and an air cleaning filter system may couple to the thermal hydrating stage to ensure metal fragments and heavy rocks are removed from the biomass in chip form prior to entering the thermal hydrating stage. The magnetic filter and the air cleaning filter system prevent any metal fragments and/or heavy rocks from plugging portions of the steam explosion unit including the discharge outlet. The air cleaning filter system assists in dropping out really heavy rocks as well as light weight sand. Note, the orifice forming the discharge outlet of the steam explosion stage may be, for example, 0.25 to 0.375 of an inch.

The steam explosion unit 108 has an input cavity to receive biomass as a feedstock, one or more steam supply inputs, and two or more stages to pre-treat the biomass for subsequent supply to a biomass gasifier 114. The stages use a combination of heat, pressure, and moisture that are applied to the biomass to make the biomass into a moist fine particle form. The steam explosion process breaks down a bulk structure of the received biomass, at least in part, by applying steam from a low pressure steam supply input to begin degrading bonds between lignin and hemi-cellulose from cellulose fibers of the biomass and increase a moisture content of the received biomass. (See for example FIG. 4B illustrating a chip of biomass having a fiber bundle of cellulose fibers surrounded and bonded together by lignin.) In the last stage, steam at least fourteen times atmospheric pressure from a high pressure steam supply input is applied to heat and pressurize any gases and fluids present inside the biomass to internally blow apart the bulk structure of the received biomass via a rapid depressurization of the biomass with the increased moisture content and degraded bonds.

In an embodiment, the two or more stages of the steam explosion unit 108 include at least a thermally hydrating stage and a steam explosion stage.

The thermally hydrating stage has the input cavity to receive chips of the biomass and the low pressure steam supply input to apply low-pressure saturated steam into a vessel containing the chips of biomass. The thermally hydrating stage is configured to receive the biomass in chip form including leaves, needles, bark, and wood. The thermally hydrating stage applies the low-pressure steam to the biomass at a temperature above a glass transition point of the lignin in order to soften and elevate the moisture content the biomass so the cellulose fibers of the biomass in the steam explosion stage can easily be internally blown apart from the biomass in chip form. In an embodiment, the chips of biomass are heated to greater than 60° C. using the steam. The low pressure steam supply input applies low-pressure saturated steam into a vessel containing the chips of biomass at an elevated temperature of above 60 degrees C. but less than 145 degrees C. at a pressure around atmospheric PSI, to start a decomposition, hydrating, and softening of the received biomass in chip form. The low pressure supply input may consist of several nozzles strategically placed around the vessel. A set of temperature sensors provides feedback on the elevated temperature of the received chips of biomass. A control system is configured to keep the chips of biomass to stay for a residence time of 8 to 20 minutes in the thermally hydrating stage, which is long enough to saturate the chips of biomass with moisture before moving out the biomass to the steam explosion stage.

The thermally hydrating stage, potentially via a screw feed system, feeds chips of biomass that have been softened and increased in moisture content to the steam explosion stage. A control system maintains a pressure of the steam explosion stage to be 10 to 30 times greater than the pressure that is present in the thermally hydrating stage and at an elevated temperature, such as a temperature of 160-270° C., 200-210° C. preferably. The pressure may be at 180-450 Pound per Square Inch (PSI) (256 PSI preferably). The steam explosion stage further raises the moisture content of the biomass to at least 40% by weight and preferably 50 to 60% moisture content by weight. The % moisture by weight may be the weight of water divided by a total weight consisting of the chips of biomass plus a water weight. In the steam explosion stage, the softened and hydrated chips of biomass are exposed to high temperature and high-pressure steam for a sufficient time period, such as 3 minutes to 15 minutes, to create high pressure steam inside the partially hollow cellulose fibers and other porous areas in the bulk structure of the biomass material. (See for example FIG. 4C illustrating a chip of biomass having a fiber bundle of cellulose fibers surrounded and bonded together by lignin but under magnification having numerous porous areas.)

After the thermally hydrating stage, the softened biomass in chip form are any combination of 1) crushed and 2) compressed into a plug form, which is then fed into a continuous screw conveyor system. The continuous screw conveyor system moves the biomass in plug form into the steam explosion stage. The continuous screw conveyor system uses the biomass in plug form to prevent blow back backpressure from the high-pressure steam present in the steam explosion stage from affecting the thermally hydrating stage. Other methods could be used such as 1) check valves and 2) moving biomass in stages where each stage is isolatable by an opening and closing mechanism.

The steam explosion stage can operate at pressures up to 850 psi but stays preferably below 450 psi. A set of sensors may detect the operating pressure. The plug screw feeder conveys the chips along the steam explosion stage. High-pressure steam is introduced into the plug screw feeder in a section called the steam mixing conveyor. The high pressure supply input may consist of several nozzles strategically placed around the steam mixing conveyor. Retention time of the biomass chip material through the steam explosion stage is accurately controlled via the plug screw feeder. In the steam explosion stage, the biomass in plug form is exposed to high temperature and high pressure steam at least 160 degree C. and 160 PSI from the high pressure steam input for at least 5 minutes and preferably around 10 minutes until moisture penetrates porous portions of the bulk structure of the biomass and all of the liquids and gases in the biomass are raised to the high pressure.

The continuous screw conveyor system feeds the biomass in plug form through the steam explosion stage to a refiner stage. The steam explosion stage may couple to a refiner stage that has one or more blades configured to mechanically agitate the pressurized biomass prior to the pressurized biomass exiting the steam explosion stage through the exit orifice to a blow line maintained at a pressure of less than a third of the pressure inside the steam explosion stage in order to internally blow apart the pressurized biomass. The mechanically agitation in the refiner stage is configured to cause resulting biomass in particle form to have a more consistent size distribution of the average dimensions of the biomass particles. The blades of the refiner stage mechanically agitate the pressurized and moistened biomass and send the agitated biomass to the orifice exit.

In an embodiment, a small opening forms the exit and goes into a tube or other container area that is maintained at around 2-10 bar of pressure and any internal fluids or gases at the high pressure expand to internally blow apart the biomass. In some cases, the pressure drop is from the high pressure in the Steam Explosion reactor all the way down to atmospheric pressure. In either case, the large pressure drop occurring in the tube or other container between the exit in the steam explosion stage and a cyclone water removal stage is dropped rapidly. In an embodiment, the pressure drop occurs rapidly by extruding the bulk structure of the biomass at between 160 to 450 PSI into a tube at the dramatically reduced pressure, such as 4-10 bar, to cause an internal “explosion” rapid expansion of steam upon the drop in pressure or due to the “flashing” of liquid water to vapor upon the drop in pressure below its vapor pressure, which internally blows apart the biomass in chip form into minute fine particles of biomass. In another embodiment, the steam explosion reactor portion of the steam explosion stage contains a specialized discharge mechanism configured to “explode” the biomass chip material to a next stage at atmospheric pressure. The discharge mechanism opens to push the biomass from the high-pressure steam explosion reactor out this reactor discharge outlet valve or door into the feed line of the blow tank.

Thus, the pressurized steam or super-heated water out of the steam explosion reactor in this stage is then dropped rapidly to cause an explosion, which disintegrates the chips of biomass into minute fine particles. (See for example FIG. 4D illustrating chips of biomass exploded into fine particles of biomass 453.) The original bundle of fibers making up the biomass is exploded into fragments making discrete particles of fine powder. (See for example FIGS. 4A-C illustrating different levels of magnification of a chip of biomass having a fiber bundle of cellulose fibers surrounded and bonded together by lignin and compare to FIG. 4D.)

The moisture and biomass chips are extruded out the reactor discharge to a container, such as the blow line, at approximately atmospheric pressure. The high-pressure steam or water conversion to vapor inside the partially hollow fibers and other porous areas of the biomass material causes the biomass cell to explode into fine particles of moist powder. The bulk structure of the biomass includes organic polymers of lignin and hemi-cellulose that surrounds a plurality of cellulose fibers. The bulk structure of the biomass is internally blown apart in this SEP step that uses at least moisture, pressure, and heat to liberate and expose the cellulose fibers to be able, as an example, to directly react during the biomass gasification reaction rather than react only after the layers of lignin and hemi-cellulose have first reacted to then expose the cellulose fibers. The high temperatures also lowers the energy/force required to breakdown the biomass' structure as there is a softening of lignin that facilitates fiber separation along the middle lamella.

The biomass produced into the moist fine particle form from the stages has average dimensions of less than 50 microns thick and less than 500 microns in length. As discussed, the steam explosion stage may couple to a refiner stage that has one or more blades configured to mechanically agitate the pressurized biomass prior to the pressurized biomass exiting the steam explosion stage through the exit orifice to a blow line. The produced fine particles of biomass with reduced moisture content includes cellulose fibers that are fragmented, torn, shredded and any combination of these and may generally have an average dimension of less than 30 microns thick and less than 250 microns in length. Those produced moist fine particles of biomass are subsequently fed to a feed section of the biomass gasifier 114.

Internally blowing apart the bulk structure of biomass in a fiber bundle into pieces and fragments of cellulose fiber, lignin and hemi-cellulose results in all three 1) an increase of a surface area of the biomass in fine particle form compared to the received biomass in chip form, 2) an elimination of a need to react outer layers of lignin and hemi-cellulose prior to starting a reaction of the cellulose fibers, and 3) a change in viscosity of the biomass in fine particle form to flow like grains of sand rather than like fibers.

The morphological changes to the biomass coming out of SEP reactor can include:
a. No intact fiber structure exists rather all parts are exploded causing more surface area, which leads to higher reaction rates in the biomass gasifier;
b. Fibers appear to buckle, they delaminate, and cell wall is exposed and cracked;
c. Some lignin remains clinging to the cell wall of the cellulose fibers;
d. Hemi-cellulose is partially hydrolyzed and along with lignin are partially solubilized;
e. The bond between lignin and carbohydrates/polysaccharides (i.e. hemi-cellulose and cellulose) is mostly cleaved; and
f. many other changes discussed herein.

The created moist fine particles may be, for example, 20-50 microns thick in diameter and less than 100 microns in length on average. Note, 1 inch=25,400 microns. Thus, the biomass comes from the chipper unit 104 as chips up to 1 inch in length and 0.25 inches in thickness on average and go out as moist fine particles of 20-50 microns thick in diameter and less than 100 microns in length on average, which is a reduction of over 2000 times in size. The violent explosive decompression of the saturated biomass chips occurs at a rate swifter than that at which the saturated high-pressure moisture in the porous areas of the biomass in chip form can escape from the structure of biomass.

Note, no external mechanical separation of cells or fibers bundle is needed rather the process uses steam to explode cells from inside outward. (See FIG. 4E illustrating a chip of biomass a chip of biomass 451 having a bundle of fibers that are frayed or partially separated into individual fibers.) Use of SEP on the biomass chips produces small fine particles of cellulose and hemi-cellulose with some lignin coating. (See FIG. 4D illustrating example chips of biomass, including a first chip of biomass 451, exploded into fine particles of biomass 453.) This composite of lignin, hemi-cellulose, and cellulose in fine form has a high surface area that can be moved/conveyed in the system in a high density.

The produced fine particles of biomass are fed downstream to the biomass gasifier 114 for the rapid biomass gasification reaction in a reactor of the biomass gasifier 114 because they create a higher surface to volume ratio for the same amount of biomass compared to the received biomass in chip form, which allows a higher heat transfer to the biomass material and a more rapid thermal decomposition and gasification of all the molecules in the biomass.

As discussed, at an exit of the steam explosion stage, once the biomass in plug form explodes into the moist fine particles form. The steam explosion stage filled with high-pressure steam and/or superheated water contains a discharge outlet configured to “explode” the biomass material to a next stage at atmospheric pressure to produce biomass in fine particle form. The biomass in fine particle form flows through a feed line of a blow tank at high velocity.

The biomass in moist fine particles form enters the feed line of the blow tank. The produced particles of biomass loses a large percentage of the moisture content due to steam flashing in the blow line and being vented off as a water vapor. The produced particles of biomass and moisture are then separated by a cyclone filter and then fed into a blow tank. Thus, a water separation unit is inline with the blow line. A collection chamber at an outlet stage of the steam explosion stage is used to collect the biomass reduced into smaller particle sizes and in pulp form and is fed to the water separation unit. Water is removed from the biomass in fine particle form in a cyclone unit and/or a dryer unit.

A moisture content of the fine particles of biomass is further dried out at an exit of the blow tank by a dryer unit such as a flash dryer or low temperature torrefaction unit that reduces the moisture content of fine particles of biomass to 0-20% by weight preferably. A goal of the fiber preparation is to create particles of biomass with maximum surface area and as dry as feasible to 5-20% moisture by weight of the outputted biomass fine particle. The flash dryer merely blows hot air to dry the biomass particles coming out from the blow tank. The flash dryer can be generally located at the outlet of the blow tank or replace the cyclone at its entrance to make the outputted biomass particles contain a greater than 5% but less than 20% moisture content by weight. The flash dryer may feed the biomass to a silo for storage to further dry out the SEP fine particles of biomass prior to being fed into a lock hopper. In an embodiment, a paddle flash dryer type can reduce the biomass particle size further due to the velocity of the gas carrying the particles going into the dryer it acts as a mill on the incoming particles of biomass.

The resulting particles of biomass differs from Thermal Mechanical Pulping (TMP) in that particles act more like crystal structures and flows easier than fibers which tend to entangle and clump. The particles also decompose more readily than fibers from a TMP process.

The fine particles of biomass out of the blow tank and flash dryer have a low moisture content. A silo may be used to further reduce the moisture of the particles if needed. The biomass gasifier 114 has a reactor vessel configured to react the biomass in moist fine particle form with an increased surface area due to being blown apart by the steam explosion unit 108. The biomass gasifier 114 has a high pressure steam supply input and one or more heaters, and in the presence of the steam the biomass in fine particle form are reacted in the reactor vessel in a rapid biomass gasification reaction between 0.1 and 40.0 second resident time to produce at least syngas components, including hydrogen (H2) and carbon monoxide (CO). When the fine particles produced are supplied in high density to the biomass gasifier 114, then the small particles react rapidly and decompose the larger hydrocarbon molecules of biomass into the syngas components more readily and completely. Thus, nearly all of the biomass material lignin, cellulose fiber, and hemi-cellulose completely gasify rather than some of the inner portions of the chip not decomposing to the same extent to that the crusted shell of a char chip decomposes. These fine particles compared to chips create less residual tar, less carbon coating and less precipitates. Thus, breaking up the integrated structure of the biomass in a fiber bundle tends to decrease an amount of tar produced later in the biomass gasification. These fine particles also allow a greater packing density of material to be fed into the biomass gasifier 114. As a side note, having water as a liquid or vapor present at least 10 percent by weight may assist in generating methanol CH3OH as a reaction product in addition to the CO and H2 produced in the biomass gasifier 114.

The torrefaction unit and biomass gasifier 114 may be combined as an integral unit.

In an embodiment, the biomass gasifier 114 is designed to radiantly transfer heat to particles of biomass flowing through the reactor design with a rapid gasification residence time, of the biomass particles of 0.1 to 30 seconds and preferably less one second. The biomass particles and reactant gas flowing through the radiant heat reactor primarily are driven from radiant heat from the surfaces of the radiant heat reactor and potentially heat transfer aid particles entrained in the flow. The reactor may heat the particles in a temperature in excess of generally 900 degrees C. and preferably at least 1200° C. to produce the syngas components including carbon monoxide and hydrogen, as well as keep produced methane at a level of ≦1%, of the compositional makeup of exit products, minimal tars remaining in the exit products, and resulting ash.

FIGS. 3-1 to 3-4 illustrate exemplary embodiments of the biomass gasifier 114. FIGS. 3-1 to 3-1C illustrate a fountain reactor using radiant heat in which entrainment gases carrying biomass enter at the bottom of the gasifier and are projected through a center tube and fountain over a separation wall created by the center tube and fall in a section created between an outer tube and the center tube. The fountain gasifier design evenly distributes the radiant heat flux. The radiant heat flux spreads from a first outer tube towards a flow of reactants in the biomass gasification or reformation reactions in the interior tube, which provides for a smaller difference between a maximum heat flux and a mean heat flux across the tubes, lowers thermal stress across the tubes, and provides a greater throughput capability of resulting product gases exiting the radiant heat-driven chemical reactor compared to a single tube design. The fountain gasifier design may also used to conduct various chemical reactions including one or more of 1) the biomass gasification (CxHyOz+(x−z)H2O->xCO+(y/2+(x−z))H2) with the particles of biomass from the steam explosion process and 2) hydrocarbon reforming or cracking, including, but not limited to, steam methane reforming (CH4+H2O->3 H2+CO), steam ethane cracking (C2H6->C2H4+H2), and steam carbon gasification (C+H2O->CO+H2), and 3) natural gas reformation reactions. The fountain gasifier design may also use heat-transfer-aid particles entrained with 1) biomass particles, 2) reactant gas, or 3) both into the radiant heat chemical reactor. The indirect radiation driven geometry of the radiant heat chemical reactor uses radiation as a primary mode of heat transfer the heat-transfer-aid particles, the reactant gas and any biomass particles entrained with the heat-transfer-aid particles. The materials of the heat-transfer-aid particles may include silica, sand, Carbo HSP, other proppants, coal, petroleum coke, and recycled ash products from the biomass gasification reaction exiting the chemical reactor and any combination of these materials, to improve heat transfer all throughout the biomass gasification reaction.

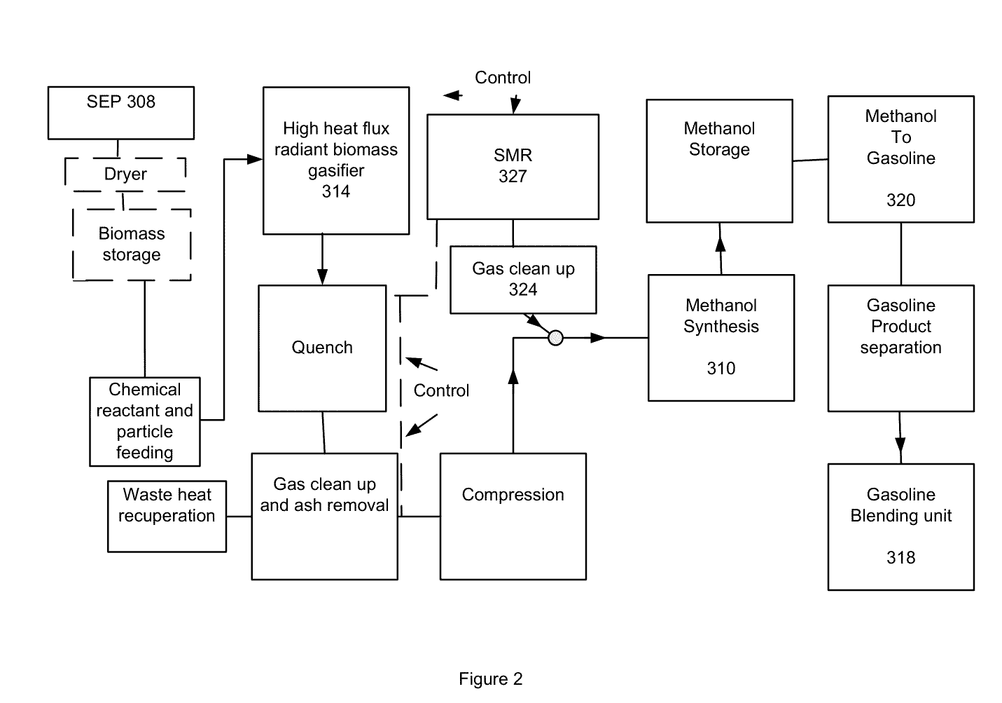

FIGS. 3-2 and 3-3 illustrate an exemplary bayonet reactor radiant heat design where a series of radiant heat tubes are used to heat injected biomass. Gas fired burners can provide heat directly to the tubes or to an intermediate source, such as a heating gas, supplied to the tubes. The biomass may be external to the tubes, while heat is supplied internal to the tubes. Alternatively, the biomass may be in between the tube sheet and the refractory lining. FIG. 3-4 illustrates an exemplary downdraft radiant heat reactor in which multiple tubes are used to provide radiant heat to the reactor. The biomass may either be external to the tubes, while heat is supplied internal to the tubes, or visa-versa.

The thermal receiver has a cavity with an inner wall. The radiation driven geometry of the cavity wall of the thermal receiver relative to the reactor tubes locates the multiple tubes of the chemical reactor inside the receiver. A surface area of the cavity walls is greater than an area occupied by the reactor tubes to allow radiation to reach areas on the tubes from multiple angles. The inner wall of the receiver cavity and the reactor tubes exchange energy primarily by radiation, with the walls and tubes acting as re-emitters of radiation to achieve a high radiative heat flux reaching all of the tubes, and thus, avoid shielding and blocking the radiation from reaching the tubes, allowing for the reactor tubes to achieve a fairly uniform temperature profile from the start to the end of the reaction zone in the reactor tubes.

Thus, the geometry of the reactor tubes and cavity wall shapes a distribution of incident radiation with these tubes that are combined with 2) a large diameter cavity wall compared to an area occupied by the enclosed tubes, and additionally 3) combined with an inter-tube radiation exchange between the multiple reactor tube geometric arrangement relative to each other where the geometry. The wall may be made of material that highly reflects radiation or absorbs and re-emits the radiation. The shaping of the distribution of the incident radiation uses both reflection and absorption of radiation within the cavity of the receiver. Accordingly, the inner wall of the thermal receiver is aligned to and acts as a radiation distributor by either 1) absorbing and re-emitting radiant energy, 2) highly reflecting the incident radiation to the tubes, or 3) any combination of these, to maintain an operational temperature of the enclosed ultra-high heat flux chemical reactor. The radiation from the 1) cavity walls, 2) directly from the regenerative burners, and 3) from an outside wall of other tubes acting as re-emitters of radiation is absorbed by the reactor tubes, and then the heat is transferred by conduction to the inner wall of the reactor tubes where the heat radiates to the reacting particles and gases at temperatures between 900 degrees C. and 1600 degrees C., and preferably above 1100 degrees C.

As discussed, the inner wall of the cavity of the receiver and the reactor tubes exchange energy between each other primarily by radiation, not by convection or conduction, allowing for the reactor tubes to achieve a fairly uniform temperature profile even though generally lower temperature biomass particles and entrainment gas enter the reactor tubes in the reaction zone from a first entrance point and traverse through the heated cavity to exit the reaction zone at a second exit point. This radiation heat transfer from the inner wall and the reactor tubes drives the chemical reaction and causes the temperature of the chemical reactants to rapidly rise to close to the temperature of the products and other effluent materials departing from the exit of the reactor.

A rapid gasification of biomass particulates with a resultant stable ash formation occurs within a residence time within the reaction zone in the reactor tubes, resulting in a complete amelioration of tar to less than 50 milligrams per normal cubic meter, and at least a 90% conversion of the biomass into the production of the hydrogen and carbon monoxide products.

To achieve high conversion and selectivity, biomass gasification requires temperatures in excess of 1000° C. These are difficult to achieve in standard fluidized bed gasifiers, because higher temperatures requires combustion of an ever larger portion of the biomass itself. As a result, indirect and fluidized bed gasification is typically limited to temperatures of 800° C. At these temperatures <800° C., production of unwanted higher hydrocarbons (tars) is significant. These tars clog up downstream equipment and foul/deactivate catalyst surfaces, requiring significant capital investment (10-30% of total plant cost) in tar removal equipment. High heat flux thermal systems are able to achieve high temperatures very efficiently. More importantly, the efficiency of the process can be controlled as a function of concentration and desired temperature, and is no longer linked to the fraction of biomass lost to achieving high temperature. As a result, temperatures in the tar cracking regime (1000-1300° C.) can be achieved without any loss of fuel yield from the biomass or overall process efficiency. This removes the complex train of tar cracking equipment typically associated with a biomass gasification system. Additionally, operation at high temperatures improves heat transfer and decreases required residence time, decreasing the size of the chemical reactor and its capital cost.

The temperatures of operation, clearly delineated with wall temperatures between 1200° C. and 1450° C. and exit gas temperatures in excess of 900° C. but not above silica melting temperatures (1600° C.) is not typically seen in gasification, and certainly not seen in indirect (circulating fluidized bed) gasification. The potential to do co-gasification of biomass and steam reforming of natural gas which can be done in the ultra-high heat flux chemical reactor could not be done in a partial oxidation gasifier (as the methane would preferentially burn). The process' feedstock flexibility derives from the simple tubular design, and most gasifiers, for reasons discussed herein, cannot handle a diverse range of fuels.

A material making up the inner wall of the receiver cavity may have mechanical and chemical properties to retain its structural strength at high temperatures between 1100-1600° C., have very high emissivity of ε>0.8 or high reflectivity of ε<0.2, as well as high heat capacity (>200 J/kg-K), and low thermal conductivity (<1 W/m-K) for the receiver cavity. A material making up the reactor tubes possesses high emissivity (ε>0.8), high thermal conductivity (>1 W/m-K), moderate to high heat capacity (>150 J/kg-K).

FIG. 2 illustrates a flow diagram of an integrated plant to generate syngas from biomass and generate a liquid fuel product from the syngas. The steam explosion unit 308 may have a steam explosion stage and thermally hydrating stage that supplies particles of biomass either to a flash dryer, a torrefaction unit, or directly to the biomass gasifier 314.

A conveying system coupled to a collection chamber at the outlet stage of the steam explosion unit 308 and cyclones supplies biomass in particle form either to a torrefaction unit, or directly to the biomass gasifier 314, or to a flash dryer. A majority of the initial lignin and cellulose making up the biomass in the receiver section of the steam tube stage in the steam explosion unit 308 remains in the produced particles of biomass but now is substantially separated from the cellulose fibers in the collection chamber at the outlet stage of the steam explosion stage 308.

The collection chamber in the steam explosion unit 308 is configured to collect non-condensable hydrocarbons from any off gases produced from the biomass during the steam explosion process.

After the steam explosion stage 308, water is removed from the biomass in a water separation unit, for example, a cyclone unit, and the reduced moisture content biomass made of loose fibers and separated lignin and cellulose may be fed to a dryer.

In an embodiment, the reduced moisture content pulp may go directly from the steam explosion unit 308 to the biomass gasifier 314, a torrefaction unit 312, or to a dryer. Generally, the particles of biomass go to the biomass gasifier 314. Note, the torrefaction unit 312 and biomass gasifier may be combined into a single unit.

The biomass gasifier 314 has a reactor configured to react particles of the biomass broken down by the two or more stages of the steam explosion unit 308 and those biomass particles are subsequently fed to a feed section of the biomass gasifier 314. The biomass gasifier 314 has a high temperature steam supply input and one or more heaters and in the presence of the steam the particles of the biomass broken down by the steam explosion unit 308 are reacted in the reactor vessel in a rapid biomass gasification reaction at a temperature of greater than 700 degrees C. in less than a five second residence time in the biomass gasifier 314 to create syngas components, including hydrogen (H2) and carbon monoxide (CO), which are fed to a methanol (CH3OH) synthesis reactor 310. In the gasifier 314, the heat transferred to the biomass particles made up of loose or fragments of cellulose fibers, lignin, and hemicellulose no longer needs to penetrate the layers of lignin and hemicellulose to reach the fibers. In some embodiments, the rapid biomass gasification reaction occurs at a temperature of greater than 700 degrees C. to ensure the removal tars from forming during the gasification reaction. Thus, a starting temperature of 700 degrees but less than 950 degrees is potentially a significant range of operation for the biomass gasifier. All of the biomass gasifies more thoroughly and readily.

The biomass gasifier 314 may have a radiant heat transfer to particles flowing through the reactor design with a rapid gasification residence time, of the biomass particles of 0.1 to 60 seconds and preferably less than 10 seconds, of biomass particles and reactant gas flowing through the radiant heat reactor, and primarily radiant heat from the surfaces of the radiant heat reactor and particles entrained in the flow heat the particles and resulting gases to a temperature in excess of generally 700 degrees C. and preferably at least 1200° C. to produce the syngas components including carbon monoxide and hydrogen, as well as keep produced methane at a level of ≦1%, of the compositional makeup of exit products, minimal tars remaining in the exit products, and resulting ash. In some embodiments, the temperature range for biomass gasification is greater than 800 degrees C. to 1400 degrees C.

Referring to FIG. 2, the plant may generate syngas for methanol production. Syngas may be a mixture of carbon monoxide and hydrogen that can be converted into a large number of organic compounds that are useful as chemical feed stocks, fuels, and solvents. For example, the biomass gasifier 314 gasifies biomass at high enough temperatures to eliminate a need for a catalyst to generate hydrogen and carbon monoxide for methanol production.

Biomass gasification is used to decompose the complex hydrocarbons of biomass into simpler gaseous molecules, primarily hydrogen, carbon monoxide, and carbon dioxide. Some mineral ash and tars can also be formed, along with methane, ethane, water, and other constituents. The mixture of raw product gases vary according to the types of biomass feedstock used and gasification processes used.

The biomass gasifier is followed by a gas clean up section to clean ash, sulfur, water, and other contaminants from the syngas gas stream exiting the biomass gasifier 314. The syngas is then compressed to the proper pressure needed for methanol synthesis. Additional syngas from steam methane reformer 327 may connect upstream or downstream of the compression stage.

The synthesis gases of H2 and CO from the gasifier and the steam methane reformer 327 are sent to the common input to the one or more methanol synthesis reactors. The exact ratio of Hydrogen to Carbon monoxide can be optimized by a control system receiving analysis from monitoring equipment on the compositions of syngas exiting the biomass gasifier 314 and steam methane reformer 327 and causing the optimize the ratio for methanol synthesis. The methanol produced by the one or more methanol synthesis reactors is then processed in a methanol to gasoline process.

The liquid fuel produced in the integrated plant may be gasoline or another such as diesel, jet fuel, or some alcohols.

Thus, both the biomass gasifier 314 and the SMR 327 can supply syngas components to the downstream organic liquid product synthesis reactor, such as methanol synthesis reactor 310. The methanol is then supplied to a methanol to gasoline process to create a high quality and high octane gasoline. The methanol may also be supplied to other liquefied fuel processes including jet fuel, DME, gasoline, diesel, and mixed alcohol.

FIGS. 4A-C illustrates different levels of magnification of an example chip of biomass 451 having a fiber bundle of cellulose fibers surrounded and bonded together by lignin.

FIG. 4D illustrates example chips of biomass, including a first chip of biomass 451, exploded into fine particles of biomass 453.

FIG. 4E illustrates a chip of biomass 451 having a bundle of fibers that are frayed or partially separated into individual fibers.

The radiant heat chemical reactor may be configured to generate chemical products including synthesis gas products. The multiple shell radiant heat chemical reactor may include a refractory vessel having an annulus shaped cavity with an inner wall. The radiant heat chemical reactor may have two or more reactor tubes made out of a solid material. The one or more reactor tubes are located inside the cavity of the refractory lined vessel.

An exothermic heat source, such as regenerative burners or gas fired burners may couple to the chemical reactor.

One or more feed lines supply biomass and reactant gas into the bottom portion of the chemical reactor. The feed lines are configured to supply chemical reactants including 1) biomass particles, 2) reactant gas, 3) steam, 4) heat transfer aid particles, or 5) any of the four into the radiant heat chemical reactor. A chemical reaction driven by radiant heat occurs in the reactor tubes.

The chemical reaction may be an endothermic reaction including one or more of 1) biomass gasification (CnHm+H2O→CO+H2+H20+X), 2) and other similar hydrocarbon decomposition reactions, which are conducted in the radiant heat chemical reactor using the radiant heat. A steam (H2O) to carbon molar ratio is in the range of 1:1 to 1:4, and the temperature is high enough that the chemical reaction occurs without the presence of a catalyst.

The biomass particles used as a feed stock into the radiant heat reactor design conveys the beneficial effects of increasing and being able to sustain process gas temperatures of excess of 1200 degrees C. through more effective heat transfer of radiation to the particles entrained with the gas, increased gasifier yield of generation of syngas components of carbon monoxide and hydrogen for a given amount of biomass fed in, and improved process hygiene via decreased production of tars and C2+ olefins. The control system for the radiant heat reactor matches the radiant heat transferred from the surfaces of the reactor to a flow rate of the biomass particles to produce the above benefits.

The control system controls the gas-fired burners to supply heat energy to the chemical reactor to aid in causing the radiant heat driven chemical reactor to have a high heat flux. The inside surfaces of the chemical reactor are aligned to 1) absorb and re-emit radiant energy, 2) highly reflect radiant energy, and 3) any combination of these, to maintain an operational temperature of the enclosed ultra-high heat flux chemical reactor. Thus, the inner wall of the cavity of the refractory vessel and the outer wall of each of the one or more tubes emits radiant heat energy to, for example, the biomass particles and any other heat-transfer-aid particles present falling between an outside wall of a given tube and an inner wall of the refractory vessel. The refractory vessel thus absorbs or reflects, via the tubes, the concentrated energy from the burners positioned along on the top and bottom of the refractory vessel in order to cause energy transport by thermal radiation and reflection to generally convey that heat flux to the biomass particles, heat transfer aid particles and reactant gas inside the chemical reactor. The inner wall of the cavity of the thermal refractory vessel and the multiple tubes act as radiation distributors by either absorbing radiation and re-radiating it to the heat-transfer-aid particles or reflecting the incident radiation to the heat-transfer-aid particles. The radiant heat chemical reactor uses an ultra-high heat flux and high temperature that is driven primarily by radiative heat transfer, and not convection or conduction.

Convection biomass gasifiers used generally on coal particles typically at most reach heat fluxes of 5-10 kW/m̂2. The high radiant heat flux biomass gasifier will use heat fluxes significantly greater, at least three times the amount, than those found in convection driven biomass gasifiers (i.e. greater than 25 kW/m̂2). Generally, using radiation at high temperature (>950 degrees C. wall temperature), much higher fluxes (high heat fluxes greater than 80 kW/m̂2) can be achieved with the properly designed reactor. In some instances, the high heat fluxes can be 100 kW/m̂2-250 kW/m̂2.

Next, the various algorithms and processes for the control system may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below. In general, the program modules may be implemented as software instructions, Logic blocks of electronic hardware, and a combination of both. The software portion may be stored on a machine-readable medium and written in any number of programming languages such as Java, C++, C, etc. but do not encompass transitory signals. The machine-readable medium may be a hard drive, external drive, DRAM, Tape Drives, memory sticks, etc. Therefore, the algorithms and controls systems may be fabricated exclusively of hardware logic, hardware logic interacting with software, or solely software.

While some specific embodiments of the design have been shown the design is not to be limited to these embodiments. For example, the recuperated waste heat from various plant processes can be used to pre-heat combustion air, or can be used for other similar heating means. Regenerative gas burners or conventional burners can be used as a heat source for the furnace. The Steam Methane Reforming may be/include a SHR (steam hydrocarbon reformer) that cracks short-chained hydrocarbons (<C20) including hydrocarbons (alkanes, alkenes, alkynes, aromatics, furans, phenols, carboxylic acids, ketones, aldehydes, ethers, etc., as well as oxygenates into syngas components. The design is to be understood as not limited by the specific embodiments described herein, but only by scope of the appended claims.

1. A chemical plant, comprising:
a radiant heat-driven chemical reactor having one or more generally concentric reactor tubes with an interior reactor tube and one or more outer reactor tubes located inside a cavity of a thermal receiver, where the chemical reactor is configured to 1) gasify particles of biomass in a presence of steam (H2O) in a biomass gasification reaction to produce a low CO2 synthesis gas that includes hydrogen, carbon monoxide gas and less than 15% CO2 by total volume generated in the gasification reaction of the particles of biomass, 2) reform natural gas in a non-catalytic reformation reaction, and 3) any combination of both, using thermal energy from a radiant heat source, where a steam supply input into the radiant heat-driven chemical reactor is in fluid communication with a source of the steam, wherein the particles of biomass or the natural gas are fed into an inner tube near a bottom of the inner tube, wherein the one or more generally concentric reactor tubes and the thermal receiver are geometrically configured to cooperate such that heat is radiantly transferred to the particles of biomass in order to provide enough energy required for the 1) biomass gasification reaction of the particles of biomass, 2) non-catalytic reformation reaction of the natural gas, and 3) any combination of both, in order to drive that reaction primarily with radiant heat to produce the low CO2 synthesis gas; wherein the one or more generally concentric reactor tubes and the thermal receiver are geometrically configured to cooperate such that heat is radiantly transferred by primarily radiation absorption and re-radiation, as well as secondarily through convection and conduction heat transfer to the reacting particles to drive the biomass gasification reaction or to inert particles accompanying natural gas in the reformation reaction.

2. The chemical plant of claim 1, where in an upper vertical section of the inner tube, turbulent flow and mixing of reactants occurs in an upper plenum section of the radiant heat-driven chemical reactor; wherein the radiant heat source is a set of one or more gas fired heaters in thermal communication with the radiant heat-driven chemical reactor and contributes with the steam to cause an operating temperature of between 900 degrees C. to 1600 degrees C. in the radiant heat-driven chemical reactor, where the one or more gas fired heaters supply heat to the 1) particles of biomass, 2) natural gas, 3) inert heat transfer particles, and 4) any combination of these traveling through the generally concentric reactor tubes, initially through an exterior wall of a most exterior outer tube of the outer reactor tubes and then inward to the interior tube in order to transfer heat to the reactants flowing in the inner and outer tubes, which limits a thermal stress difference between a maximum heat flux and a mean heat flux felt across each of the interior and outer reactor tubes.

3. The chemical plant of claim 1, where the upper plenum section mixes and breaks up agglomerates of the particles of biomass or other solids, while distributing heat evenly, and directs the biomass particles or other reactants down into a first outer tube to continue the biomass gasification reaction and ensure that at least greater than 80% of the carbon material in the biomass particles fed into the inner tube is reacted and converted into products within the concentric reactor tubes of the radiant heat-driven chemical reactor.

4. The chemical plant of claim 1, wherein the radiant heat-driven chemical reactor is configured to use the one or more generally concentric reactor tubes with the interior reactor tube and the one or more outer tubes reactor tubes in a shape of a fountain to evenly distribute a radiant heat flux, where the radiant heat flux spreads from a first outer tube towards a flow of reactants in the biomass gasification or non-catalytic reformation reactions in the interior reactor tube, which provides for a smaller difference between a maximum heat flux and a mean heat flux across the interior and outer reactor tubes, lowers thermal stress across the interior and outer reactor tubes, and provides a greater throughput capability of resulting product gases exiting the radiant heat-driven chemical reactor compared to a single tube design, and
wherein an entrainment gas source is coupled to the radiant heat-driven chemical reactor, and is configured to provide an entrainment gas at a high enough velocity to carry the biomass particles entering from the bottom of the inner tube generally vertically or upward through the inner tube into an upper plenum, where turbulent gas flow occurs in the upper plenum to evenly distribute the heat to the 1) biomass particles being carried, 2) natural gas flowing as a reactant gas, and 3) any combination of both, where one or more flow diverters exist in the upper plenum to shape a flow of the turbulent flow and mixing as well as direct any reactant gas and biomass particles down into a first outer tube.

5. The chemical plant of claim 1, wherein the radiant heat-driven chemical reactor has one or more inlets for biomass and entrainment gas coupled through a lower portion of the inner tube, where a generally annular space is provided between the inner tube and outer tube with an exit area at a lower portion of the outer tube, where the inner tube and the outer tube are longitudinally offset, so that a lower end of the inner tube may extend beyond the lower end of the outer tube, and an upper end of the outer tube may extend beyond the upper end of the inner tube, where the upper end of the outer tube is closed to create a mixing area in a space above the inner tube and within the walls of the outer tube.

6. The chemical plant of claim 1, wherein the radiant heat-driven chemical reactor couples to the radiant heat source such that heat is supplied to the particles of biomass through an exterior wall of a most exterior of the outer reaction tubes, where a fountain configuration of the concentric reactor tubes causes the particles of biomass to pass through the radiant heat-driven chemical reactor along two or more passes, including a first upward pass through the interior reactor tube and then a second downward pass through an annular space between the interior and outer reactor tubes, wherein the concentric reactor tubes are made from i) a ceramic material, ii) a metal coated with a ceramic, iii) a metal lined with a ceramic, iv) a refractory metal coated with a ceramic, v) a refractory metal lined or clad with an oxidation resistant metal, or vi) any combination of these.

7. The chemical plant of claim 1, wherein an entrainment gas source is coupled to the radiant heat-driven chemical reactor, and is configured to provide an entrainment gas at a high enough velocity to carry the biomass particles entering from the bottom of the inner tube generally vertically or upward through the interior tube into an upper plenum wherein the radiant heat-driven chemical reactor uses a counter pressure thrust mechanism at a top of the upper plenum in order to counteract an upward thrust force exerted by a combination of the reactant products, the entrainment gas, and any inert particles that create pressure on the top part of the upper plenum, and
where the counter pressure thrust mechanism incorporates either 1) a spring or 2) a hydraulic thrust maintenance system in order to generate the counter pressure thrust at the top of the upper plenum.

8. The chemical plant of claim 1, wherein an integrated plant includes a steam explosion unit, the radiant heat-driven chemical reactor to generate syngas from either the biomass gasification reaction or the non catalytic reformation reaction, and a methanol synthesis reactor to generate methanol from the generated syngas, where the steam explosion unit applies a combination of heat, pressure, and moisture to biomass received in the steam explosion unit to make the received biomass into a moist, fine particle form, where the steam explosion unit is configured to apply steam with a high pressure to heat and pressurize any gases and fluids present inside the received biomass to internally blow apart a bulk structure of the received biomass via a rapid depressurization of the received biomass when exiting the steam explosion unit, where those produced moist, fine particles of biomass are subsequently fed to a feed section of the radiant heat-driven chemical reactor, which reacts the biomass particles in a rapid biomass gasification reaction to produce syngas components, where a particle size of the biomass is generally less than 1 mm and preferably less than 500 microns, and the produced syngas components are fed into the methanol synthesis reactor.

9. The chemical plant of claim 1, wherein the radiant heat-driven chemical reactor with the concentric reactor tubes' design is used to reform merely the natural gas in a non-catalytic reformer of natural gas.

10. The chemical plant of claim 1, wherein the radiant heat-driven chemical reactor with the concentric reactor tubes' design is used to decompose and gasify merely the particles of biomass in the biomass gasification reaction.

11. The chemical plant of claim 1, wherein walls of a vessel containing the concentric reactor tubes are made of materials that have a low thermal conductivity characteristic and the concentric reactor tubes are made of materials that have high thermal conductivity characteristic of equal to or greater than 20 Watts per meter Kelvin making up, wherein the walls of the vessel and the reactor tubes are configured to allow the particles of biomass and any reactant gas to achieve and maintain a high enough temperature of 850 degrees C. or greater necessary for substantial tar destruction to less than 50 mg/m̂3 and gasification of greater than 80 percent of a carbon content of the particles of biomass into reaction products including the hydrogen and the carbon monoxide gas.

12. The chemical plant of claim 1, wherein the concentric configuration of the interior reactor tube and the outer reactor tubes allows a greater throughput capability of reactants to flow through the inner and outer tubes while maintaining at least a conversion of at least 80 percent of the biomass into product gases and ash as set by a maximum heat flux allowable across a boundary between adjacent tubes, and wherein the inner and outer tube configuration allows more reactant material to flow through the tubes, with a mean heat flux closer in value to a maximum heat flux.

13. The chemical plant of claim 1, wherein a spacing distance ratio is set between an outer diameter of the interior reactor tube and an inner diameter of a first outer reactor tube, to be between 1:3 and 1:5 in order to maintain a velocity of the flowing reactants and properly exchange energy via a radiant heat energy exchange.

14. A biomass gasifier, comprising:
a multiple concentric tube fountain configuration, where the tube fountain configuration permits entrainment gases and particles of biomass to enter and exit from a common end of the biomass gasifier, wherein the biomass gasifier includes concentric tubes configured to inject the entrainment gas and the particles of biomass into an interior tube at one end, and collect an output from the biomass gasifier at the one end from an area between the concentric tubes; and
a radiant heat source to provide radiant heat through a vessel wall of the biomass gasifier inward towards the interior tube, where primarily a heat transfer mechanism is via radiant heat to the particles of biomass and any inert heat transfer aids flowing with the particles of biomass in the entrainment gas to cause a biomass gasification reaction to generate at least syngas components.

15. The apparatus of claim 14, wherein the interior tube extends longitudinally beyond an outer tube at the first end.

16. The apparatus of claim 15, wherein the outer tube extends longitudinally above the interior tube at a second end opposite the first end.

17. The apparatus of claim 16, wherein the outer tube comprises a spring adjacent the second end, wherein the second end of the outer tube is maintained at a fixed position during the biomass gasification reaction, and the spring is configured to regulate, control, and maintain a system pressure.

18. The apparatus of claim 17, wherein the hydraulic system comprises a pressure monitor to determine the system pressure within the biomass gasifier, a controller, and a hydraulic piston to alter a longitudinal location of the second end of the outer tube depending on the system pressure.

19. The apparatus of claim 15, wherein the outer tube is inwardly tapered, wherein a mixing zone is created longitudinally beyond the interior tube's second end and within the outer tube, wherein the entrainment gas and the particles of biomass mix in a turbulent flow in the mixing zone and transition into a different direction of flow in the mixing zone.

20. The apparatus of claim 19, wherein the biomass gasifier is configured such that the entrainment gas and the particles of biomass pass through the interior tube, flows over the interior tube second end, and down an annular space between the interior tube and outer tube.
